(19) United States
(12) Patent Application Publication
(10) Pub. No.: US 2015/0003200 A1
(43) Pub. Date: Jan. 1, 2015

(54) SYSTEM AND METHOD FOR DETERMINING THE POSITION OF A SENSOR IN SEISMIC EXPLORATION

(71) Applicant: Mike Hall, Calgary (CA)

(72) Inventor: Mike Hall, Calgary (CA)

(21) Appl. No.: 14/310,636

(22) Filed: Jun. 20, 2014

Related U.S. Application Data
(60) Provisional application No. 61/840,833, filed on Jun. 28, 2013.

(51) Int. Cl. G01V 1/30

(52) U.S. Cl. CPC G01V 1/30
USPC 367/38

(57) ABSTRACT

A system and method for determining the position of a sensor in seismic exploration is disclosed. The method includes directing first, second, and third sensors to emit first, second, and third signals respectively; recording first, second, and third emitted times corresponding to emitting the first, second, and third signals respectively; detecting that a fourth sensor received the first, second, and third signals; recording first, second, and third received times corresponding to receiving the first, second, and third signals respectively; calculating, based on emitted and received times, a first distance between the first and fourth sensors, a second distance between the second and fourth sensors, and a third distance between the third and fourth sensors; determining the positions of the first, second, and third sensors; and computing a position of the fourth sensor based on the positions of the first, second, and third sensors, and the first, second, and third distances.

### CROSS-REFERENCE TO RELATED APPLICATION

This application claims the benefit under 35 U.S.C. §119(e) of U.S. Provisional Application Ser. No. 61/840,833 filed on Jun. 28, 2013. entitled “Positioning Sensors on Land,” which is incorporated by reference in its entirety for all purposes.

### TECHNICAL FIELD

The present disclosure relates generally to seismic exploration tools and processes and, more particularly, to a system and method for determining the position of a sensor in seismic exploration.

### BACKGROUND

In the oil and gas industry, geophysical survey techniques are commonly used to aid in the search for and evaluation of subterranean hydrocarbon or other mineral deposits. Generally, a seismic energy source, or “source,” generates a seismic signal that propagates into the earth and is partially reflected by subsurface seismic interfaces between underground formations having different acoustic impedances. The reflections are recorded by seismic detectors, or “sensors,” located at or near the surface of the earth, in a body of water, or at known depths in boreholes, and the resulting seismic data can be processed to yield information relating to the location and physical properties of the subsurface formations. Seismic data acquisition and processing generates a profile, or image, of the geophysical structure under the earth's surface. While this profile does not provide an accurate location for oil and gas reservoirs, it suggests, to those trained in the field, the presence or absence of them.

Various sources of seismic energy have been used to impart the seismic waves into the earth. Such sources have included two general types: 1) impulsive energy sources and 2) seismic vibrator sources. The first type of geophysical prospecting utilizes an impulsive energy source, such as dynamite or a marine air gun, to generate the seismic signal. With an impulsive energy source, a large amount of energy is injected into the earth in a very short period of time. In the second type of geophysical prospecting, a vibrator is used to propagate energy signals over an extended period of time, as opposed to the near instantaneous energy provided by impulsive sources. Except where expressly stated herein, “source” is intended to encompass any seismic source implementation, both impulse and vibratory, including any dry land or marine implementations thereof.

The seismic signal is emitted in the form of a wave that is reflected off interfaces between geological layers. The reflected waves are received by an array of geophones, or sensors, located at the earth's surface, which convert the displacement of the ground resulting from the propagation of the waves into an electrical signal recorded by means of recording equipment. The sensors typically receive data during the source's energy emission and during a subsequent “listening” interval. The recording equipment records the time at which each reflected wave is received. The travel time from source to sensor, along with the velocity of the source wave, can be used to reconstruct the path of the waves to create an image of the subsurface. A large amount of data may be recorded by the recording equipment and the recorded signals may be subjected to signal processing before the data is ready for interpretation. The recorded seismic data may be processed to yield information relating to the location of the subsurface reflectors and the physical properties of the subsurface formations. That information is then used to generate an image of the subsurface.

Sensors may be arranged in cable-based sensor arrays where sensors are connected to each other via a cable. Data received by the sensors is transmitted to a recording unit. At the recording unit, the data is recorded and stored for later use. Sensors may also be arranged in nodal-based sensor arrays. In nodal-based arrays, the array may contain one or more nodes. Each node is connected, either via a cable or wirelessly, to one or more sensors. The sensors transmit data to the node and each node transmits data to the recording unit. The node may be connected to the recording unit via a cable or wirelessly. The node may also act as a recording unit and may not transmit data to a separate recording unit.

Sensor position data is needed for data processing. The sensor position data may include the location of the sensor on the surface of the earth or the location of the sensor relative to other sensors in the array. For example, the position of a sensor is used when calculating the travel time from a source to a sensor. The position of a sensor may be determined via land survey techniques, global positioning systems (GPS), or any other suitable technique for determining the position of an object. Land survey techniques offer a high degree of accuracy but are time consuming as each sensor in an array is surveyed. GPS has an average accuracy of plus or minus one meter and may not be as time consuming as land survey techniques. However, to use GPS to locate a sensor, a GPS-equipped sensor is necessary. In typical nodal systems, only the node includes a GPS sensor.

The use of nodal-based systems is increasing, however GPS is only used to determine the position of each node and not the position of the sensor or sensors connected to it. Along with the increasing use of nodes, there is an increasing use of shorter distances between the sensor stations and a subsequent increase in the density of sensors within a given area. In some instances sensors connected to a single node may be a substantial distance from the node, for example greater than approximately fifty meters. In other instance the separation between sensors may be less than approximately ten meters, requiring a greater accuracy in determining the position of the sensors.

### SUMMARY

In accordance with some embodiments of the present disclosure, a method of determining the position of a sensor in seismic exploration is disclosed. The method includes directing a first sensor to emit a first signal, a second sensor to emit a second signal, and a third sensor to emit a third signal. The method further includes recording a first emitted time corresponding to emitting the first signal a second emitted time corresponding to emitting the second signal and a third emitted time corresponding to emitting the third signal. The method further includes detecting that a fourth sensor received the first signal, the second signal, and the third signal. The method further includes recording a first received time corresponding to receiving the first signal, a second received time corresponding to receiving the second signal, and a third received time corresponding to receiving the third signal. The method further includes calculating a first distance between the first sensor and the fourth sensor based on the first emitted time and the first received time, a second distance between the second sensor and the fourth sensor based on the second emitted time and the second received time, and a third distance between the third sensor and the fourth sensor based on the third emitted time and the third received time. The method further includes determining a position of the first sensor, a position of the second sensor, and a position of the third sensor. The method further includes computing a position of the fourth sensor based on the position of the first sensor, the position of the second sensor, the position of the third sensor, the first distance, the second distance, and the third distance.

In accordance with another embodiment of the present disclosure, a seismic exploration system is disclosed. The system includes a first sensor configured to emit a signal, a second sensor configured to emit a signal, and a third sensor configured to emit a signal. The system further includes a fourth sensor configured to receive the signal. The system further includes a unit communicatively coupled to the first sensor, the second sensor, the third sensor, and the fourth sensor. The unit is configured to direct the first sensor to emit a first signal, the second sensor to emit a second signal, and the third sensor to emit a third signal; record a first emitted time corresponding to emitting the first signal a second emitted time corresponding to emitting the second signal and a third emitted time corresponding to emitting the third signal; detect that the fourth sensor received the first signal, the second signal, and the third signal; record a first received time corresponding to receiving the first signal, a second received time corresponding to receiving the second signal, and a third received time corresponding to receiving the third signal; calculate a first distance between the first sensor and the fourth sensor based on the first emitted time and the first received time, a second distance between the second sensor and the fourth sensor based on the second emitted time and the second received time, and a third distance between the third sensor and the fourth sensor based on the third emitted time and the third received time; determine a position of the first sensor, a position of the second sensor, and a position of the third sensor; and compute a position of the fourth sensor based on the position of the first sensor, the position of the second sensor, the position of the third sensor, the first distance, the second distance, and the third distance.

In accordance with a further embodiment of the present disclosure, a non-transitory computer-readable medium is disclosed. The computer-readable medium includes computer-executable instructions carried on the computer-readable medium. The instructions, when executed, cause a processor to direct a first sensor to emit a first signal, a second sensor to emit a second signal, and a third sensor to emit a third signal; record a first emitted time corresponding to emitting the first signal a second emitted time corresponding to emitting the second signal and a third emitted time corresponding to emitting the third signal; detect that a fourth sensor received the first signal, the second signal, and the third signal; record a first received time corresponding to receiving the first signal, a second received time corresponding to receiving the second signal, and a third received time corresponding to receiving the third signal; calculate a first distance between the first sensor and the fourth sensor based on the first emitted time and the first received time, a second distance between the second sensor and the fourth sensor based on the second emitted time and the second received time, and a third distance between the third sensor and the fourth sensor based on the third emitted time and the third received time; determine a position of the first sensor, a position of the second sensor, and a position of the third sensor; and compute a position of the fourth sensor based on the position of the first sensor, the position of the second sensor, the position of the third sensor, the first distance, the second distance, and the third distance.

### BRIEF DESCRIPTION OF THE DRAWINGS

For a more complete understanding of the present disclosure and its features and advantages, reference is now made to the following description, taken in conjunction with the accompanying drawings, in which like reference numbers indicate like features and wherein:

FIG. 1 illustrates a sensor array, or an area, containing sensors of both known and unknown positions in accordance with some embodiments of the present disclosure;

FIG. 2 illustrates a flow chart of an example method for determining the position of sensors in seismic exploration in accordance with some embodiments of the present disclosure; and

FIG. 3 illustrates an elevation view of an example seismic exploration system configured to produce images of the earth's subsurface geological structure in accordance with some embodiments of the present disclosure.

### DETAILED DESCRIPTION

Seismic exploration survey data where the reflected signal is recorded by a sensor whose position is not precisely known may not be as accurate as data recorded by a sensor whose position is precisely known. Identifying the position of each sensor, whether they are in sensor array or solitary, is expensive and time consuming. Therefore, according to the teachings of the present disclosure, systems and methods are presented that determine the position of a sensor in a sensor array based upon determining the position of the sensor relative to the known positions of other sensors. The use of the systems and methods presented allows for improved sensor position information for use in data processing and also saves time and money when deploying sensors. The design of a sensor configuration where the unknown position of a sensor in the sensor configuration can be determined based on the known position of other points in the sensor configuration and the systems needed to create it are further understood with reference to the figures and the following discussion.

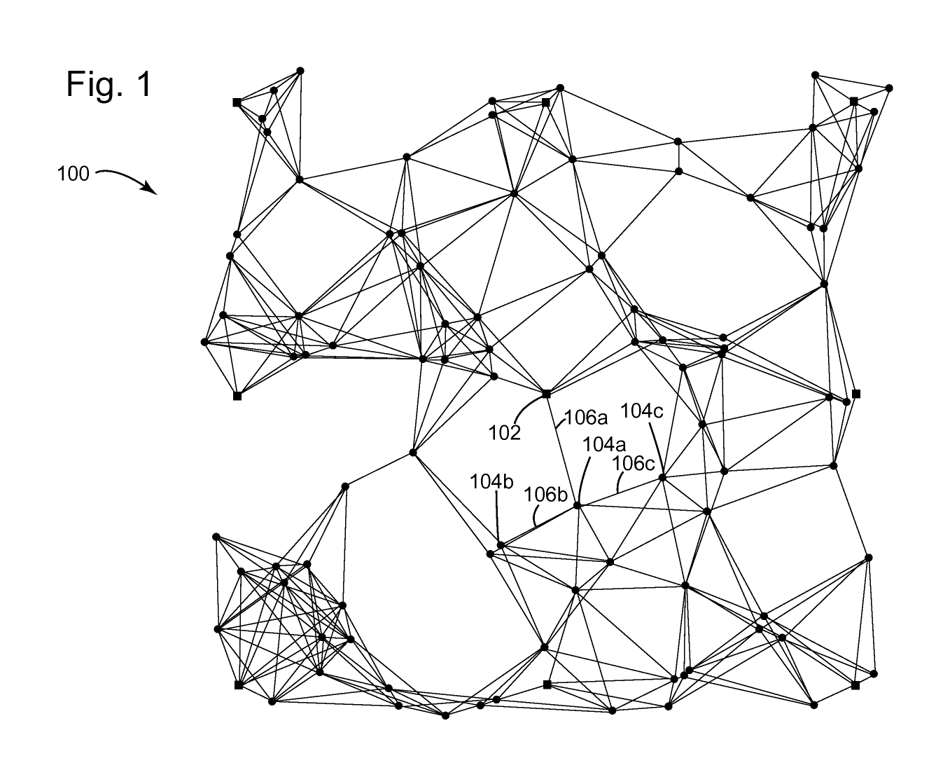

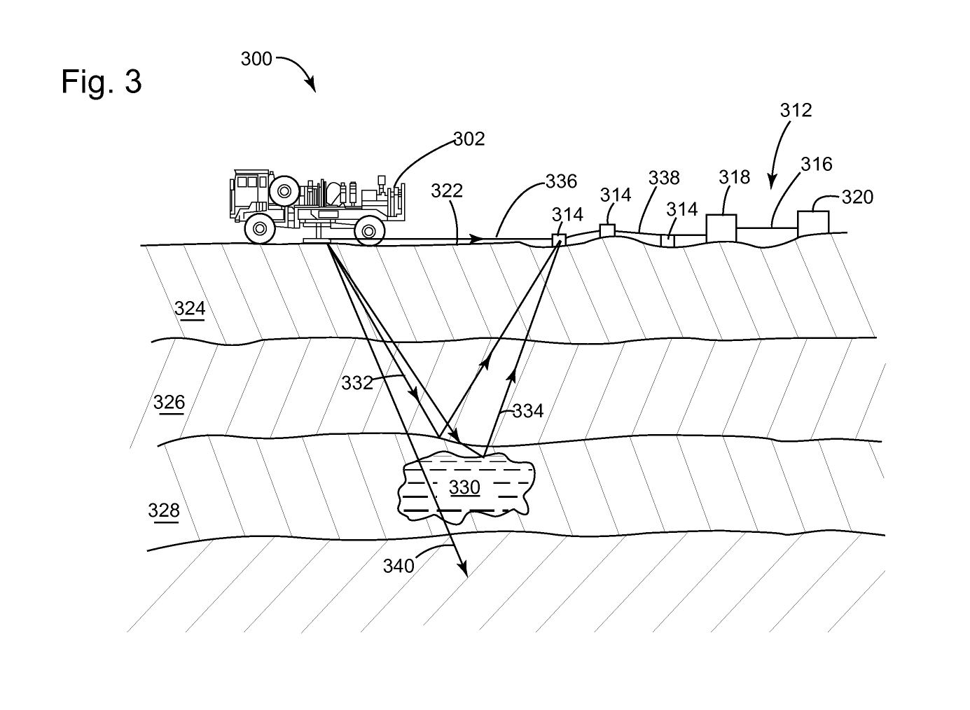

As an example of a configuration of sensors where the positions of some sensors are known and the positions of other sensors are unknown, FIG. 1 illustrates a sensor configuration containing sensors of both known and unknown positions in accordance with some embodiments of the present disclosure. In sensor array 100, the position of sensor 102 is known and the positions of sensors 104 are unknown. The position of sensor 102 may be determined via land surveying techniques, global positioning systems (GPS), or any other suitable method of determining the position of an object. Sensor array 100 may include any number of sensors, for example, sensor array 100 may include over one-thousand sensors. Sensor array 100 may include sensors located on cables and each cable may include hundreds of sensors. Sensors 102 and 104 may be connected to nodes (not expressly shown) to facilitate communication to a recording unit, as discussed further with respect to FIG. 3.

The position of sensor 104a can be determined by computing the distance between sensor 104a and the sensors surrounding sensor 104a, such as sensor 102 and sensors 104b and 104c. A signal, such as an acoustic tone, radiofrequency (RF) signal, or any other suitable communications mechanism, may be used to calculate the distance between sensor 104 the sensors surrounding sensor 104a (e.g., sensor 102 and sensors 104b and 104c). Sensors 102 and 104 may be configured to emit a signal and receive a signal. For example, sensor 102 may include a signal generator which generates a signal based on a command and may include a receiver to receive signals generated by sensors 104. Sensors 102 and 104 may receive signals via a microphone, an acoustic transducer, or any other suitable means for detecting signals. Sensors 102 and 104 may record, or transmit to a recording unit, the time at which sensors 102 and 104 emits signals. Sensors 102 and 104 may receive signals and a recording unit may record the time at which the signals are received.

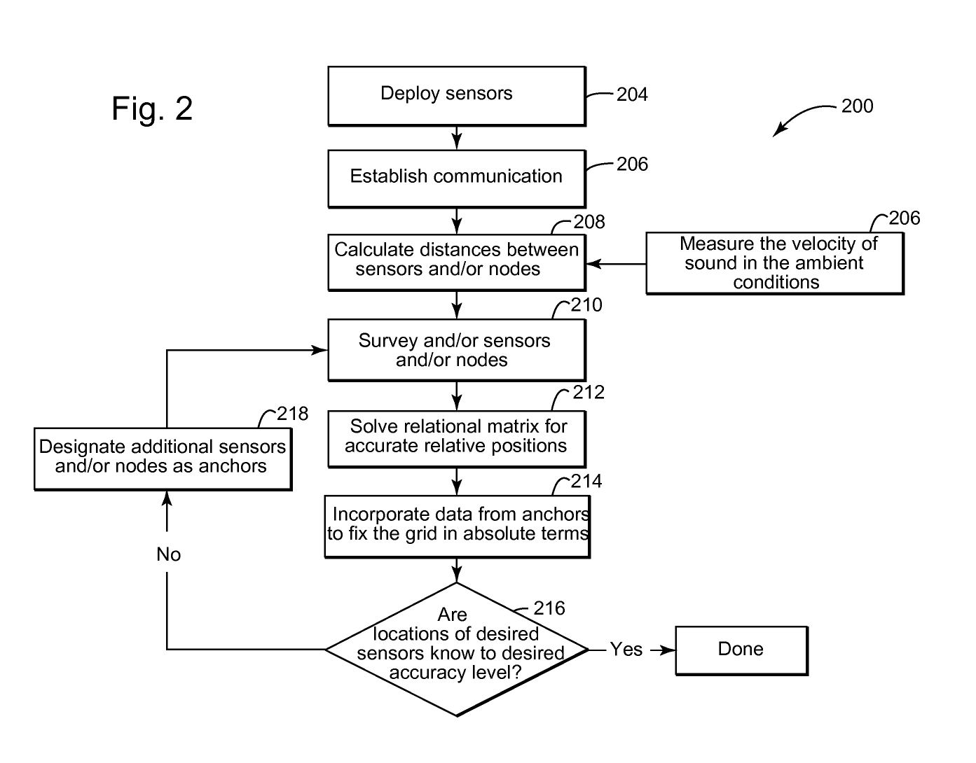

In some embodiments, a given sensor 102 or 104 may communicate with any sensor 102 or 104 within range of the given sensor 102 or 104. The range of a given sensor 102 or 104 may be limited by the receiving equipment included in sensor 102 or 104. The communication between sensors may be used to determine the relative distances between two sensors, as described in more detail with reference to FIG. 2. Sensors 102 or 104 may communicate with acquisition nodes (not expressly shown). In some embodiments sensors 102 or 104 may communicate with the acquisition nodes to which the sensor is connected. In other embodiments, sensors 102 or 104 may communicate with acquisitions nodes to which the sensor is not connected, in addition to communicating with the connected acquisition node. The acquisition nodes may be located with GPS, however the GPS signal may not be sufficient to determine the position of the acquisition node with sufficient accuracy to allow the acquisition nodes to be used as anchor points. Therefore, the position of the acquisition nodes may be determined using the same calculation methods as described with respect to sensor 104a.

In a given sensor configuration, there may be a small number of sensors and nodes with known, surveyed positions, also known as “anchor points.” For example, approximately less than one percent of sensors and nodes may have known positions and serve as anchor points. For example, sensor 102 may be an anchor point. In some embodiments, an anchor point may not be a sensor and may be an independent piece of signal generating equipment. In other embodiments, an anchor point may be located on a node of a sensor array.

The positions of sensors 104 are unknown. The distance between each sensor 102 and 104 may be calculated based on the travel time of the signal between each of sensor 102 and 104. For example, if the signal is an acoustic tone, the distance may be calculated with reference to the velocity of sound through air. The distance between sensors 102, 104b, and 104c and sensor 104a may be calculated by:

D=c·t (1)

where
D=the distance between sensors;
c=the velocity of sound through air; and
t=the travel time of the signal between the sensors.
   The velocity of sound through air varies based on the ambient temperature. The ambient temperature at the position of sensor array 100 may be determined through a measurement recorded by a component of sensor array 100, through a measurement recorded by measuring equipment at the seismic survey site, by accessing information from a weather service, or any other suitable means of determining the temperature of a position.

The distances between sensor 104a and each sensor 102, 104b, and 104c may provide the position of sensor 104a relative to each sensor 102, 104b, and 104c, referred to as the “relative position.” The relative position of sensor 104a may be used to calculate the absolute position of sensor 104a. The absolute position of sensor 104a is the position of sensor 104a on the surface of the earth and is not defined relative to another point. To calculate the distance between sensor 104a and sensors 102, 104b, and 104c, a recording unit may record the travel time, to sensor 104a, of a signal from sensor 102, a signal from sensor 104b, and a signal from sensor 104c. Based upon each travel time, distances 106a, 106b, and 106c may be calculated using Equation (1), representing the distance between sensor 104a and sensors 102, 104b, and 104c, respectively. Distances 106a-106c may be collectively referred to as “distances 106.”

Once distances 106 are known, the relative position of sensor 104a may be determined. The relative position of sensor 104a may be determined through a relational matrix of the position of sensor 104a relative to sensors 102, 104b, and 104c. The relational matrix may be calculated using geometric calculation methods such as methods to solve a Euclidean distance matrix, trilateration, or any other suitable geometric solution method. A Euclidean distance matrix is a mathematical representation of a matrix representing the spacing of a set of points in space. Trilateration is a process in geometry for determining the absolute position of points by measurements of distances from known points. In trilateration, the distance from a known point to an unknown point is designated as the radius of a sphere having its center at the known point. If multiple distances between the unknown point and known points are known, multiple spheres can be defined. The position of the unknown point can be determined by calculating the position where the spheres intersect.

After determining the relative position of sensor 104a, the absolute position of sensor 104a may be calculated. The position of the anchor points may be combined with the relational matrix to enable the calculation of the absolute position of sensor 104a. For example, using geometric solution methods, the distance from one or more anchor points, such as sensor 102, and the distances between sensor 104a and the anchor points can enable the calculation of the absolute position of sensor 104a.

Each sensor 102 and 104 may be assigned a “unique identifier” to identify the position of that particular sensor 102 and 104. Unique identifiers may be assigned proceeding from south to north or any other suitable assignment method. The information on relative distances between sensors 102 and/or 104 may be stored in a central database based on the unique identifier. The central database of relative distances may then be used to calculate the position of sensors 104. While FIG. 1 is described with reference to a few sensors 102 and 104, there may be thousands of sensors and numerous anchor points having similar capabilities in sensor array 100.

FIG. 2 illustrates a flow chart of example method 200 for determining the position of sensors in seismic exploration in accordance with some embodiments of the present disclosure. Determination of the position of sensors based on the known position of other sensors may allow for improved sensor position information for use in data processing and also reduce time and expense when locating sensors in a sensor array. The steps of method 200 can be performed by a user, various computer programs, models, or any combination thereof, configured to simulate, design, and analyze data from seismic exploration signal systems, apparatuses, or devices. The programs and models may include instructions stored on a computer-readable medium and operable to perform, when executed, one or more of the steps described above. The computer-readable media can include any system, apparatus, or device configured to store and retrieve programs or instructions such as a hard disk drive, a compact disc, flash memory, or any other suitable device. The programs and models may be configured to direct a processor or other suitable unit to retrieve and execute the instructions from the computer-readable media. Collectively, the user or computer programs and models used to simulate, design, and analyze data from seismic exploration systems may be referred to as a “seismic processing tool.”

The method 200 begins at step 202, where the sensors may be deployed at the seismic survey site. In some embodiments, sensors may be arranged in cable-based sensor arrays where sensors are connected to each other via a cable. Each cable may include hundreds of sensors. In other embodiments, a sensor array may include nodal-based sensors where the sensors may be connected to nodes to facilitate communication to a recording unit. In further embodiments, the sensors may be arranged in any other type of configuration for a sensor array. A sensor array may include any number of sensors, for example, a sensor array may include over one-thousand sensors.

In step 204, the seismic processing tool may establish communication between the sensors and nodes in the sensor array. The communication may be established through communication via acoustic tone, RF signal, or any other suitable communications mechanism. The sensors and nodes may communicate by sensors and nodes generating a signal and other sensors and nodes receiving the signals. Sensors may receive signals from the other sensors within communication range. The communication range may be limited based on the receiving equipment included in the sensors, the terrain at the seismic survey site, the atmospheric conditions at the survey site, or any other constrain on the communication range. The sensors, or another piece of recording equipment such as the seismic processing tool, may record the time at which the signals are emitted. The signals may be emitted at different times or at different frequencies to allow for identification of the signal from each sensor. For example, sensor 102 may emit a signal at a time or frequency different from the signal emitted by sensor 104b, as shown with reference to FIG. 1. The sensors, or another piece of recording equipment such as the seismic processing tool, may record the time at which the signals are received. In an embodiment where more than one signal is emitted, the frequency of the signal may also be recorded in order to allow for identification of each individual signal. For example, the signal emitted by sensor 102 may be received by sensor 104a, shown in FIG. 1 and the time at which the signal was received and the frequency of the signal may be recorded. The difference between the time a signal is received and the time the signal is emitted may be referred to as the travel time of the signal and may be used to calculate the distance between the sensors in step 208.

In step 206, the seismic processing tool may measure the velocity of sound through air under the ambient conditions at the seismic survey site. The velocity of sound may vary based on the ambient temperature at the seismic survey site. The ambient temperature may be recorded by the seismic processing tool or by separate equipment located at the seismic survey site, such as a thermocouple or a thermometer. The velocity of sound in air may be calculated by:

c=\sqrt{kRT} (2)

where
c=the velocity of sound;
k=the ratio of specific heats (k=1.4 for air);
R=the gas constant (R=286.9 J/kg K for air); and
T=the ambient temperature.

In step 208, the seismic processing tool may calculate the distance between sensors, such as between sensor 104a and sensor 102, as shown in FIG. 1. For an acoustic signal, the distance between the sensors is calculated based on the speed of sound and the travel time of the signal, calculated in steps 206 and 204, respectively. The distance may be calculated using Equation (1).

In step 210, the seismic processing tool may survey the position of one or more sensors or nodes which are designated as anchor points. In some embodiments an anchor point may be a component of a sensor array, such as a sensor or a node. In other embodiments the anchor point may be a piece of equipment separate from the sensors or the nodes. The positions of the anchor points may be determined based on land surveying techniques, GPS, or any other suitable method for identifying the position of an object on the surface of the earth. For example, the anchor point may be sensor 102, as shown in FIG. 1. The number of anchor points in a sensor array may be based on the size of the sensor array and may include, for example, less than approximately one percent of the number of sensors in the array.

In step 212, the seismic processing tool may solve a relational matrix to determine the relative positions of the sensors. The relational matrix may be a matrix of the positions of the sensors relative to other sensors in the sensor array. The relational matrix can be calculated using geometric calculation methods such as methods to solve a Euclidean distance matrix, trilateration, or any other geometric solution method. The relative positions of the sensors may be based on the distances between the sensors and nodes, as calculated in step 208.

In step 214, the seismic processing tool may determine the absolute position of the sensors. The absolute position of the sensors may be calculated by incorporating the surveyed position of the anchor points into the relational matrix of the relative positions of the sensors, as calculated in steps 210 and 212, respectively. By incorporating the surveyed positions of the anchor points, the absolute position of the sensors can be fixed based on the positions of the sensors relative to the anchor points. For example, the absolute position of sensor 104a may be determined based on the surveyed position of sensor 102, as shown in FIG. 1.

In step 216, the seismic processing tool may determine whether the positions of the sensors are known to a preferred accuracy level. The preferred accuracy level may be based on the requirements of the seismic survey. For example, the seismic processing tool may determine whether the positions of each sensor are known within plus or minus less than approximately one meter. If the positions of the sensors are known to the preferred accuracy level, method 200 may be complete. Otherwise method 200 may proceed to step 218.

In step 218, the seismic processing tool may designate additional sensors or nodes to be anchor points. An increased number of anchor points may increase the accuracy of the calculation of the absolute position of the sensors, as calculated in step 214. Once the seismic processing tool has designated additional sensors or nodes as anchor points, method 200 may proceed to step 210 to survey the newly designated anchor points.

Modifications, additions, or omissions may be made to method 200 without departing from the scope of the present disclosure. For example, the order of the steps may be performed in a different manner than that described and some steps may be performed at the same time. For example, step 210 may occur at any point in method 200. Additionally, each individual step may include additional steps without departing from the scope of the present disclosure. Further, more steps may be added or steps may be removed without departing from the scope of the disclosure.

The method described with reference to FIG. 2 is used to enhance the effectiveness of a system used to emit seismic signals, receive reflected signals, and process the resulting data to image the earth's subsurface. FIG. 3 illustrates an elevation view of an example seismic exploration system 300 configured to produce images of the earth's subsurface geological structure in accordance with some embodiments of the present disclosure. The images produced by system 300 allow for the evaluation of subsurface geology. System 300 may include one or more seismic energy sources 302 and one or more sensors 314 which are located within a pre-determined exploration area. Sensors 314 may be the same as sensors 102 and 104 discussed with reference to FIG. 1. The exploration area may be any defined area selected for seismic survey or exploration. Survey of the exploration area may include the activation of seismic source 302 that radiates an acoustic wave field that expands downwardly through the layers beneath the earth's surface. The seismic wave field is then partially reflected from the respective layers as a wave front received by sensors 314. For example, source 302 generates seismic waves and sensors 314 receive rays 332 and 334 reflected by interfaces between subsurface layers 324, 326, and 328, oil and gas reservoirs, such as target reservoir 330, or other subsurface structures. Subsurface layers 324, 326, and 328 may have various densities, thicknesses, or other characteristics. Target reservoir 330 may be separated from surface 322 by multiple layers 324, 326, and 328. As the embodiment depicted in FIG. 3 is exemplary only, there may be more or fewer layers 324, 326, or 328 or target reservoirs 330. Similarly, there may be more or fewer rays 332 and 334. Additionally, some source waves will not be reflected, as illustrated by ray 340.

Seismic energy source 302 may be referred to as an acoustic source, seismic source, energy source, and source 302. In some embodiments, source 302 is located on or proximate to surface 322 of the earth within an exploration area. A particular source 302 may be spaced apart from other similar sources. Source 302 may be operated by a central controller that coordinates the operation of several sources 302. Further, a positioning system, such as a GPS, may be utilized to locate and time-correlate sources 302 and sensors 314. Multiple sources 302 may be used to improve testing efficiency, provide greater azimuthal diversity, improve the signal to noise ratio, and improve spatial sampling. The use of multiple sources 302 can also input a stronger signal into the ground than a single, independent source 302. Sources 302 may also have different capabilities and the use of multiple sources 302 may allow for some sources 302 to be used at lower frequencies in the spectrum and other sources 302 at higher frequencies in the spectrum.

Source 302 may include any type of seismic device that generates controlled seismic energy used to perform reflection or refraction seismic surveys, such as a seismic vibrator, vibroseis, dynamite, an air gun, a thumper truck, or any other suitable seismic energy source. Source 302 may radiate varying frequencies or one or more monofrequencies of seismic energy into surface 322 and subsurface formations during a defined interval of time. Source 302 may impart energy through a sweep of multiple frequencies or at a single monofrequency, or through a combination of at least one sweep and at least one monofrequency. A signal may be discontinuous so that source 302 does not generate particular frequencies between the starting and stopping frequency and sensors 314 do not receive or report data at the particular frequencies. Source 302 may also include microseismic sources and passive seismic sources.

A seismic signal may be also generated by a SEISMOVIE™ system designed and manufactured by CGG Services SA (Massy, France). A SEISMOVIE™ system may emit energy at individual frequencies, one-by-one, until approximately the entire frequency band is emitted. When emitted signals are generated utilizing a SEISMOVIE™ system, signals at one or more specific frequencies may not be emitted, which may result in higher seismic exploration efficiency. Signals from a SEISMOVIE™ system may also be emitted at a different energy level for each frequency.

Seismic exploration system 300 may include monitoring device 312 that operates to record reflected energy rays 332, 334, and 336. Monitoring device 312 may include one or more sensors 314, network 316, recording unit 318, and processing unit 320. For example, sensors 314 may be any sensor 102 or 104 as shown in FIG. 1. In some embodiments, monitoring device 312 may be located remotely from source 302.

Sensor 314 may be located on or proximate to surface 322 of the earth within an exploration area. Sensor 314 may be any type of instrument that is operable to transform seismic energy or vibrations into a voltage signal. For example, sensor 314 may be a vertical, horizontal, or multicomponent geophone, accelerometers, optical fiber, or distributed acoustic sensors (DAS) with wire or wireless data transmission, such as a three component (3C) geophone, a 3C accelerometer, or a 3C Digital Sensor Unit (DSU). Multiple sensors 314 may be utilized within an exploration area to provide data related to multiple positions and distances from sources 302. Sensors 314 may be positioned in multiple configurations, such as linear, grid, array, or any other suitable configuration. In some embodiments, sensors 314 may be positioned along one or more strings 338. Each sensor 314 is typically spaced apart from adjacent sensors 314 in the string 338. Spacing between sensors 314 in string 338 may be approximately the same preselected distance, or span, or the spacing may vary depending on a particular application, exploration area topology, or any other suitable parameter. Sensors 314 may be configured to emit or receive a signal as described with respect to FIGS. 1 and 2.

One or more sensors 314 transmit raw seismic data from reflected seismic energy via network 316 to recording unit 318. Recording unit 318 transmits raw seismic data to processing unit 320 via network 316. Processing unit 320 performs seismic data processing on the raw seismic data to prepare the data for interpretation. For example, processing unit 320 may perform the distance and position calculations described in steps 208, 212, and 214 of method 200. Although discussed separately, recording unit 318 and processing unit 320 may be configured as separate units or as a single unit. Recording unit 318 or processing unit 320 may include any instrumentality or aggregation of instrumentalities operable to compute, classify, process, transmit, receive, store, display, record, or utilize any form of information, intelligence, or data. For example, recording unit 318 and processing unit 320 may include one or more personal computers, storage devices, servers, or any other suitable device and may vary in size, shape, performance, functionality, and price. Recording unit 318 and processing unit 320 may include random access memory (RAM), one or more processing resources, such as a central processing unit (CPU) or hardware or software control logic, or other types of volatile or non-volatile memory. Additional components of recording unit 318 and processing unit 320 may include one or more disk drives, one or more network ports for communicating with external devices, and one or more input/output (I/O) devices, such as a keyboard, a mouse, or a video display. Recording unit 318 or processing unit 320 may be located in a station truck or any other suitable enclosure. Recording unit 318 may configured to record the information related to the signal described with respect to FIG. 2, such as the times the signal is emitted and received, the frequency of the signal, and the ambient temperature.

Network 316 may be configured to communicatively couple one or more components of monitoring device 312 with any other component of monitoring device 312. For example, network 316 may communicatively couple sensors 314 with recording unit 318 and processing unit 320. Further, network 314 may communicatively couple a particular sensor 314 with other sensors 314. Network 314 may be any type of network that provides communication, such as one or more of a wireless network, a local area network (LAN), or a wide area network (WAN), such as the Internet. For example, network 314 may provide for communication of reflected energy and noise energy from sensors 314 to recording unit 318 and processing unit 320.

The seismic survey may be repeated at various time intervals to determine changes in target reservoir 330. The time intervals may be months or years apart. Data may be collected and organized based on offset distances, such as the distance between a particular source 302 and a particular sensor 314 and the amount of time it takes for rays 332 and 334 from a source 302 to reach a particular sensor 314. Data collected during a survey by sensors 314 may be reflected in traces that may be gathered, processed, and utilized to generate a model of the subsurface structure or variations of the structure, for example 4D monitoring. The method described with respect to FIG. 2 may be used to locate sensors to enable accurate calculation of the offset distances between a particular source and a particular sensor.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. For example, a sensor does not have to be turned on but must be configured to receive reflected energy.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described. For example, the computer processor may serve to calculate the distances between a sensor and the anchor point and the position of a sensor as described in steps 208, 212, and 214 with respect to FIG. 2.

Embodiments of the present disclosure may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer-readable storage medium or any type of media suitable for storing electronic instructions, and coupled to a computer system bus. Furthermore, any computing systems referred to in the specification may include a single processor or may be architectures employing multiple processor designs for increased computing capability.

Although the present disclosure has been described with several embodiments, a myriad of changes, variations, alterations, transformations, and modifications may be suggested to one skilled in the art, and it is intended that the present disclosure encompass such changes, variations, alterations, transformations, and modifications as fall within the scope of the appended claims. Moreover, while the present disclosure has been described with respect to various embodiments, it is fully expected that the teachings of the present disclosure may be combined in a single embodiment as appropriate. Instead, the scope of the present disclosure is defined by the appended claims.

What is claimed is:

1. A method of determining the position of a sensor in seismic exploration, comprising:
directing a first sensor to emit a first signal, a second sensor to emit a second signal, and a third sensor to emit a third signal;
recording a first emitted time corresponding to emitting the first signal, a second emitted time corresponding to emitting the second signal, and a third emitted time corresponding to emitting the third signal;
detecting that a fourth sensor received the first signal, the second signal, and the third signal;
recording a first received time corresponding to receiving the first signal, a second received time corresponding to receiving the second signal, and a third received time corresponding to receiving the third signal;
calculating a first distance between the first sensor and the fourth sensor based on the first emitted time and the first received time;
calculating a second distance between the second sensor and the fourth sensor based on the second emitted time and the second received time;
calculating a third distance between the third sensor and the fourth sensor based on the third emitted time and the third received time;
determining a position of the first sensor, a position of the second sensor, and a position of the third sensor; and
computing a position of the fourth sensor based on the position of the first sensor, the position of the second sensor, the position of the third sensor, the first distance, the second distance, and the third distance.

2. The method of claim 1, wherein the first sensor, the second sensor, or the third sensor is a node of a sensor array or is independent of a component of a sensor array.

3. The method of claim 1, wherein determining the position of the first sensor, the position of the second sensor, and the position of the third sensor includes:
selecting one of the first sensor, the second sensor, or the third sensor; and
surveying or calculating the position of the selected sensor.

4. The method of claim 1, further comprising:
determining whether an accuracy level of the position of the fourth sensor is above a predetermined threshold;
based on the determination that the accuracy level of the position of the fourth sensor is above the predetermined threshold, designating a fifth sensor to survey;
directing the fifth sensor to emit a fourth emitted signal;
recording a fourth emitted time corresponding to emitting the fourth signal;
detecting that the fourth sensor received the fourth signal;
recording a fourth received time corresponding to receiving the fourth signal;
calculating a fourth distance between the fourth sensor and the fifth sensor based on the fourth emitted time and the fourth received time;
determining a position of the fifth sensor; and
computing a position of the fourth sensor based on the position of the fifth sensor and the fourth distance.

5. The method of claim 1, further comprising recording an ambient temperature.

6. The method of claim 1, wherein the position of the fourth sensor is computed by solving a Euclidean distance matrix.

7. The method of claim 1, further comprising recording a frequency of the first signal.

8. A seismic exploration system, comprising:
a first sensor configured to emit a signal;
a second sensor configured to emit a signal;
a third sensor configured to emit a signal;
a fourth sensor configured to receive the signal; and
a unit communicatively coupled to the first sensor, the second sensor, the third sensor, and the fourth sensor, the unit configured to:
direct the first sensor to emit a first signal, the second sensor to emit a second signal, and the third sensor to emit a third signal;
record a first emitted time corresponding to emitting the first signal, a second emitted time corresponding to emitting the second signal, and a third emitted time corresponding to emitting the third signal;
detect that the fourth sensor received the first signal, the second signal, and the third signal;
record a first received time corresponding to receiving the first signal, a second received time corresponding to receiving the second signal, and a third received time corresponding to receiving the third signal;
calculate a first distance between the first sensor and the fourth sensor based on the first emitted time and the first received time;
calculate a second distance between the second sensor and the fourth sensor based on the second emitted time and the second received time;
calculate a third distance between the third sensor and the fourth sensor based on the third emitted time and the third received time;
determine a position of the first sensor, a position of the second sensor, and a position of the third sensor; and
compute a position of the fourth sensor based on the position of the first sensor, the position of the second sensor, the position of the third sensor, the first distance, the second distance, and the third distance.

9. The seismic exploration system of claim 8, wherein the first sensor, the second sensor, or the third sensor is a node of a sensor array or is independent of a component of a sensor array.

10. The seismic exploration system of claim 8, wherein determining the position of the first sensor, the position of the second sensor, and the position of the third sensor includes:
selecting one of the first sensor, the second sensor, or the third sensor; and
surveying or calculating the position of the selected sensor.

11. The seismic exploration system of claim 8, the unit further configured to:
determine whether an accuracy level of the position of the fourth sensor is above a predetermined threshold;
based on the determination that the accuracy level of the position of the fourth sensor is above the predetermined threshold, designate a fifth sensor to survey;
direct the fifth sensor to emit a fourth emitted signal;
record a fourth emitted time corresponding to emitting the fourth signal;
detect that the fourth sensor received the fourth signal;
record a fourth received time corresponding to receiving the fourth signal;
calculate a fourth distance between the fourth sensor and the fifth sensor based on the fourth emitted time and the fourth received time;
determine a position of the fifth sensor; and
compute a position of the fourth sensor based on the position of the fifth sensor and the fourth distance.

12. The seismic exploration system of claim 8, the unit further configured to record an ambient temperature.

13. The seismic exploration system of claim 8, wherein the position of the fourth sensor is computed by solving a Euclidean distance matrix.

14. The seismic exploration system of claim 8, the unit further configured to record a frequency of the first signal.

15. A non-transitory computer-readable medium, comprising:
computer-executable instructions carried on the computer-readable medium, the instructions, when executed, causing a processor to:
direct a first sensor to emit a first signal, a second sensor to emit a second signal, and a third sensor to emit a third signal;
record a first emitted time corresponding to emitting the first signal, a second emitted time corresponding to emitting the second signal, and a third emitted time corresponding to emitting the third signal;
detect that a fourth sensor received the first signal, the second signal, and the third signal;
record a first received time corresponding to receiving the first signal, a second received time corresponding to receiving the second signal, and a third received time corresponding to receiving the third signal;
calculate a first distance between the first sensor and the fourth sensor based on the first emitted time and the first received time;
calculate a second distance between the second sensor and the fourth sensor based on the second emitted time and the second received time;
calculate a third distance between the third sensor and the fourth sensor based on the third emitted time and the third received time;
determine a position of the first sensor, a position of the second sensor, and a position of the third sensor; and
compute a position of the fourth sensor based on the position of the first sensor, the position of the second sensor, the position of the third sensor, the first distance, the second distance, and the third distance.

16. The non-transitory computer-readable medium of claim 15, wherein the first sensor, the second sensor, or the third sensor is a node of a sensor array or is independent of a component of a sensor array.

17. The non-transitory computer-readable medium of claim 15, wherein determining the position of the first sensor, the position of the second sensor, and the position of the third sensor includes:
selecting one of the first sensor, the second sensor, or the third sensor; and
surveying or calculating the position of the selected sensor.

18. The non-transitory computer-readable medium of claim 15, the computer-executable instructions further causing the processor to:
determine whether an accuracy level of the position of the fourth sensor is above a predetermined threshold;
based on the determination that the accuracy level of the position of the fourth sensor is above the predetermined threshold, designate a fifth sensor to survey;
direct the fifth sensor to emit a fourth emitted signal;
record a fourth emitted time corresponding to emitting the fourth signal;
detect that the fourth sensor received the fourth signal;
record a fourth received time corresponding to receiving the fourth signal;
calculate a fourth distance between the fourth sensor and the fifth sensor based on the fourth emitted time and the fourth received time;
survey a position of the fifth sensor; and
compute a position of the fourth sensor based on the position of the fifth sensor and the fourth distance.

19. The non-transitory computer-readable medium of claim 15, the computer-executable instructions further causing the processor to record an ambient temperature.

20. The non-transitory computer-readable medium of claim 15, the computer-executable instructions further causing the processor to record a frequency of the first signal.
